(19) United States
(12) Patent Application Publication
(10) Pub. No.: US 2006/0005470 A1
(43) Pub. Date: Jan. 12, 2006

(54) Door threshold protective cover

(76) Inventors: Pat Mullen, Encinitas, CA (US); Gary Crouch, Carlsbad, CA (US); Dan Mullen, El Cajon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/134,058

(22) Filed: May 20, 2005

Related U.S. Application Data
(60) Provisional application No. 60/574,517, filed on May 21, 2004.

(51) Int. Cl. E06B 1/70

(52) U.S. Cl. 49/467

(57) ABSTRACT

A protective device is provided in which the protective device comprises an upper surface configured to fit over a door threshold and the fasteners which ordinarily secure the threshold are also utilized to secure the protective device. In certain embodiments, the protective device may be formed from a translucent or transparent plastic, so as to enable the accurate placement of apertures within the device. A method for installing a protective device is also provided, which includes placing the protective device over a door threshold and securing it in place using the same fasteners which are used to secure the threshold. In certain embodiments, the method may include trimming the device to fit the doorway, or forming apertures in the device to receive the fasteners.

### CROSS-REFERENCE TO RELATED APPLICATIONS

This application claims priority under 35 U.S.C.§ 119(e) to U.S. Provisional Application Ser. No. 60/574,517, filed on May 21, 2004, which is incorporated by reference in its entirety.

### BACKGROUND OF THE INVENTION

1. Field of the Invention

This invention relates to protective devices.

2. Description of the Related Art

During construction of buildings and homes, it is quite common for door thresholds to become damaged by construction traffic, paint, and the like. Accordingly, a variety of door threshold protectors have been developed. These include the protectors described in U.S. Pat. Nos. 5,588,266; 6,216,395; and 6,269,591, as well as U.S. Patent Publication No. 2003/0126826. Each of these documents is incorporated by reference.

It is one aspect of prior art door threshold protectors that installation is inconvenient or even damaging. The door protector described in U.S. Pat. 5,588,266 requires a specific threshold design to provide threshold engagement. The devices of U.S. Pat. Nos. 6,216,395 and 6,269,591 use double sided tape to secure the protector to the threshold, which can come loose and leave residue behind after removal. The device described in U.S. Publication 2003/0126826 requires the formation of additional screw holes in the threshold or the indoor or outdoor surfaces adjacent to the doorway.

Although these devices do function to protect the threshold, they are in general relatively difficult to install and inconvenient to use. An improved threshold protector would be beneficial in the construction environment.

### SUMMARY OF THE INVENTION

In one embodiment, a protective device is provided, including a device body including a top protective panel configured to overlie a door threshold, where at least a portion of the top protective panel is non-opaque, at least one aperture in the device body; and at least one fastener extending through the device body, where the fastener secures the protective device to the door threshold and secures the door threshold in place.

In another embodiment, a protective device is provided, including a top cover portion configured to overlie a door threshold, at least one substantially vertical side wall, at least one aperture in the top cover portion of the protective device, and at least one fastener extending through the at least one aperture, where the fastener secures the protective device to the door threshold and secures the door threshold in place.

In yet another embodiment, a method of installing a protective device is provided, including placing the protective device over a door threshold and securing both the protective device and the door threshold with the same fastener, where the securing includes inserting at least one fastener through an aperture in the protective device.

In yet another embodiment, a protective device is provided, including a top protective panel configured to overlie a door threshold, wherein at least a portion of the top protective panel is non-opaque.

In yet another embodiment, a protective device is provided, including a protective shield and means for securing the shield to a threshold, where the securing means also provide means for securing the threshold in place.

### BRIEF DESCRIPTION OF THE DRAWINGS

FIG. 1 is a side view of a first embodiment of a door threshold protector.

FIG. 2 is a side view of a second embodiment of a door threshold protector.

FIG. 3 illustrates the embodiment of FIG. 2 installed on a door threshold.

FIG. 4 illustrates one suitable installation embodiment.

FIG. 5 illustrates a threshold protector installed in a doorway.

### DETAILED DESCRIPTION OF THE PREFERRED EMBODIMENT

The following detailed description is directed to certain specific embodiments of the invention. However, the invention can be embodied in a multitude of different ways. In this description, reference is made to the drawings wherein like parts are designated with like numerals throughout.

In some embodiments of the present invention, the above problems are resolved by allowing the threshold protector to be retained in place by the same screws that retain the threshold itself in place. If the threshold screw pattern is known, the screw holes can be pre-drilled in the protector at the appropriate locations. However, when the threshold screw pattern is not known, an embodiment of a threshold protector may advantageously comprise non-opaque plastic, so that the holes in the threshold can be easily seen through the overlying threshold protector. In such an embodiment, the screw can be screwed directly down through the hole, or a nail or punch can be used to make starter holes for the threshold screws which can then be driven through the protector and into their normal locations in the threshold. In most embodiments, starter holes will not be necessary as an electric screwdriver will easily drive a screw through the plastic protector body.

Because such embodiments utilize screw holes which already exist in the threshold itself, the threshold protector can then be removed, and the screw reinserted into the screw holes to retain the threshold as normal. Thus, no damage is produced by this fixation method, unlike the threshold protectors discussed above. Such embodiments provide additional advantages in that no additional fixture hardware, such as fasteners or adhesive tape, is required for protector fixation.

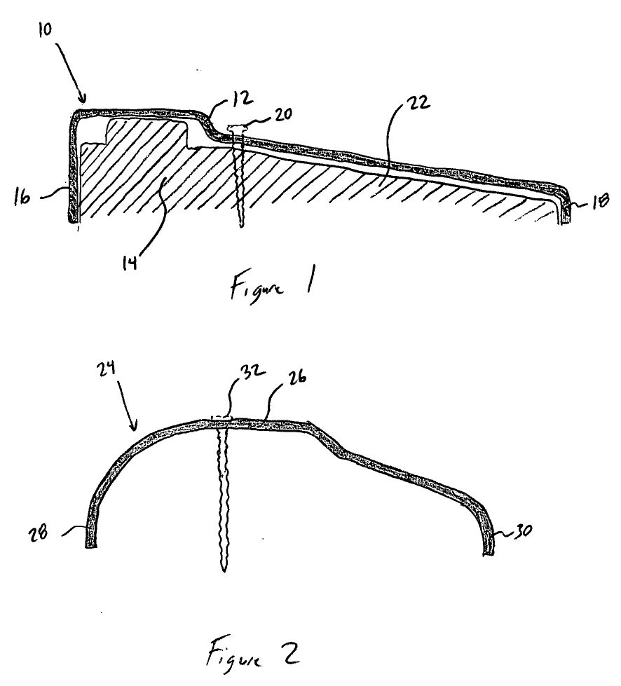

FIG. 1 illustrates a side view of a threshold protector 10. As can be seen, the protector 10 comprises an upper portion 12, which is contoured to fit over a threshold 14. The protector 10 also comprises side walls 16 and 18, which protect the sides of the threshold 14. A fastener 20, which in this case is a screw, but may be in other embodiments any other appropriate fastener, has been inserted through an aperture in the upper portion 12 of the threshold protector and into the preexisting corresponding aperture in the threshold 14. Typically, the fastener 20 will extend through both the threshold body and into the concrete slab. In some building construction, a 2×4 sleeper is placed in the slab at the door threshold locations, and the threshold is screwed into that. In either case, the fastener 20 extends through the protector and the threshold and into whatever support the threshold is attached to. For convenience, the corresponding aperture is referred to as a screw hole, although it will be understood that alternate fasteners and corresponding apertures can be utilized. As can be seen, the threshold 14 comprises an elongate portion 22 having a shallow slope, and the top protective panel 12 of the protector 10 is shaped to match this slope. The threshold 10 is thus configured to fit over and protect a threshold 14 comprising an elongate portion 22, such as those thresholds utilized in the construction of fire doors, and entry/exit doors.

The protector 10 is advantageously comprised of a plastic, and is advantageously transparent or translucent, for the reasons discussed above. However, in alternate embodiments, particularly in embodiments in which the screw placement of the threshold is previously known and the apertures in the threshold protector 10 have been pre-formed, opaque materials may be used in the fabrication of the protector. In further embodiments, only the portion of the threshold protector which overlies the area where the threshold screw holes are likely to be located may comprise a non-opaque material. The threshold protector may be formed from a longer protector which is cut to fit within the door. Advantageously, in an embodiment in which the threshold protector is to be cut to an appropriate size, the apertures in the threshold protector are not pre-formed, as it may be difficult to precisely cut the protector such that the preformed holes in the protector are aligned with the screw holes.

Materials suitable for the fabrication of the protector 10 include, but are not limited to, acrylic, Polyethelene (PE), Low Density Polyethelene (LDPE), polypropylene (PP), or a blend of several plastics, such as LDPE and PP. The protector 10 may be manufactured by any appropriate process, including plastic extrusion or injection molding. It can be seen that in certain embodiment, the threshold protector has a substantially constant cross-sectional shape, and extrusion may thus be an appropriate manufacturing process.

As can be seen, the protector 10 of FIG. 1 may contoured without necessarily matching the exact contours of the underlying threshold 14. Rather, the shape of the threshold 10 is advantageously designed so as to fit over a variety of potential threshold shapes. In alternate embodiments, where the exact shape of the threshold to be protected is known, these protectors may be manufactured so as to fit very closely over the threshold 12. The use of protectors having specialized contours may provide additional advantages, such as a reduced risk of slippage and easier installation.

Because in certain applications, the threshold protector may be installed after the door has been installed, the threshold protector should have a thickness which is small enough to permit clearance of the door over the protector. For certain applications, a thickness about 30 mil or possibly less in some cases has been found to provide both sufficient clearance and sufficient protection. It will be understood that different thicknesses may be appropriate depending on the design of the door and the materials used in the fabrication of the threshold.

Although in certain embodiments, using the same fasteners used to secure the threshold is the primary fixation method, secondary or alternate fixation methods can be used. For example, the side walls 16 and 18 may be formed so as to not be parallel to one another, but rather be directed inward, such that a slight deformation of the protector is required to place it over the threshold 14. This deformation will result in the walls 16 and 18 being biased against the threshold. Alternately, flanges or tabs could be used, such as at the edges of the walls 16 or 18, to provide additional or alternate fixation methods. Adhesive tape could be used, as well, either to fix the protector 10 to the threshold 14 or to protect portions of the threshold 14 which may be left uncovered by the threshold protector 10.

Because the threshold protector 10 may be used in high traffic areas, such as construction sites, it may be desirable to provide anti-slip features as a safety measure. These anti-slip features may take the form of ridges of plastic along the upper surface of the top protective panel 12 of the protector 10. Alternately, the upper surface of the top protective panel 12 may be roughened, or an adhesive, such as for example friction tape, may be applied to the upper surface.

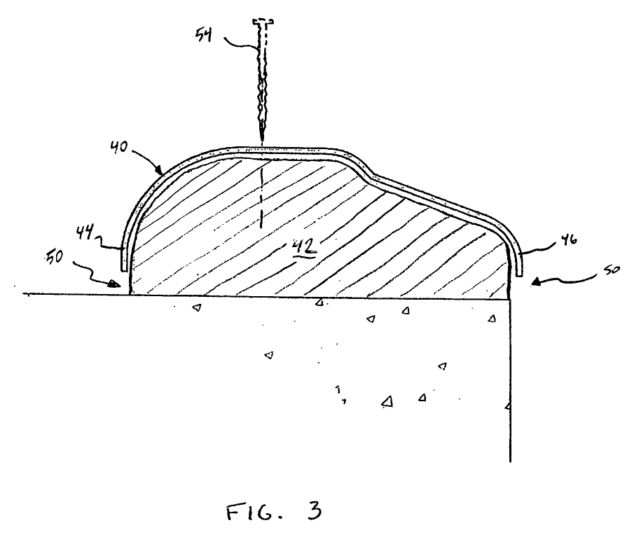

FIG. 2 depicts a side view of another embodiment of a threshold protector 24. It can be seen that the upper surface 26 of the threshold protector 24 is substantially more rounded than that of the threshold protector, and the side walls 28 and 30 are less pronounced. Thus, the protector 24 is configured to fit over thresholds having significantly different shapes than the threshold 14 of FIG. 1. For instance, in one embodiment, the threshold protector 24 of FIG. 2 is configured to fit over and protect a threshold of the shape commonly utilized in the construction of French doors. As discussed with respect to the threshold protector 10 of FIG. 1, a fastener 32 is used to fix the protector 24 of FIG. 2 to an underlying threshold (not shown), using the same fasteners and screw holes used to secure the threshold.

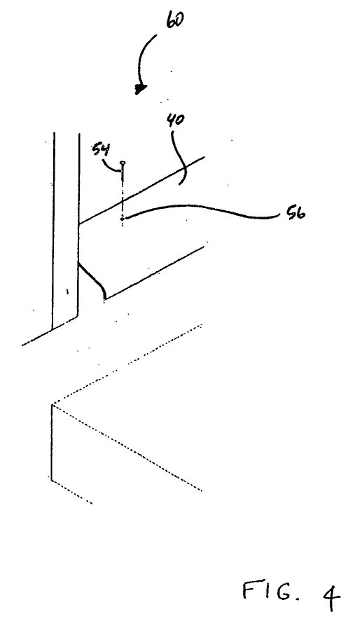

In certain embodiments, the threshold protector may be designed such that the side walls of the protector do not extend down to the floor underlying the threshold, as illustrated in FIG. 3. As can be seen, a threshold protector 40 (which has a shape similar to that of the protector 24 of FIG. 2), overlies a threshold 42, to which it is secured by a fastener 54. The side walls 44 and 46 of the protector 40 do not extend down to the surface of the floor 48, but rather leave gaps 50 between the bottom of the side walls and the floor.

In the embodiment of FIG. 3, the gaps 50 advantageously permit certain additional work to be done without the need to remove the protector 40, such as caulking the lower edge of the threshold 42. In further embodiments, the gaps 50 may be of sufficient size to permit other tasks, such as the installation of flooring, to be done without removal of the protector 40. Although portions of the threshold 40 may be exposed due to the gaps 50, damage to the sides of the threshold is less likely than damage to the upper portion of the threshold, and secondary protection, such as adhesive tape, can be used to protect the exposed portions, as discussed above.

The method of installing a threshold protector of the types discussed above will vary depending on the application. In certain embodiments, the method comprises removal of the fasteners securing the threshold, followed by the placement of the threshold protector over the threshold, and use of the same fasteners to both fix the protector to the underlying threshold, and secure the threshold in place. Preferably, the threshold is installed at the same time as the threshold protector, such that no removal of the fasteners is required. This method advantageously facilitates easier installation of the protector, and serves to protect the threshold from the time of installation until the point at which the protector is removed. In a particularly advantageous method, once the threshold is ready to be put into place (such as after the threshold has been cut to the proper size), a protector, which may be pre-cut or cut at this time, is placed over the threshold, and the two components are installed at the same time.

In certain embodiments, as discussed above, the method advantageously comprises trimming the protector so as to fit the door. In further or alternate embodiments, the method may comprise forming apertures in the protector after placement of the threshold protector over the threshold.

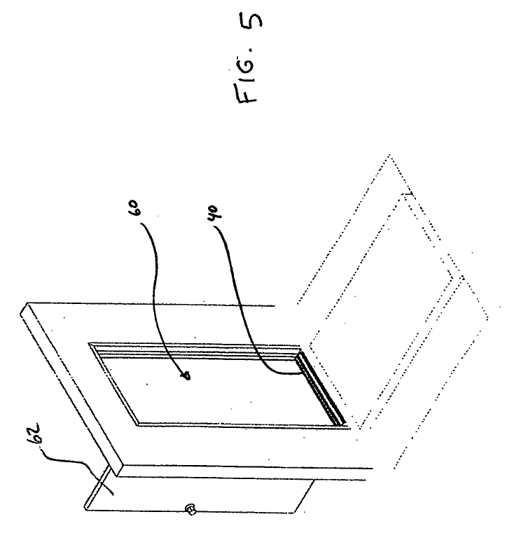

FIG. 4 is an exploded view illustrating the installation of a protector 40 in a doorway 60. As can be seen, the fastener 54 which would ordinarily secure the threshold is inserted through an aperture 56 in the protector so as to both fix the protector to the threshold, and secure the threshold in place. FIG. 5 is a perspective view depicting a threshold protector 40 installed in a doorway 60. As discussed above, the thickness of the threshold protector 40 is preferably selected to be sufficiently thin to permit clearance of the door 62, so that the protector does not inhibit the closing of the door.

The threshold protector embodiments described above can be re-used if desired. As a set of homes or other buildings are completed, they can be removed from the thresholds in the completed structures, and placed on thresholds of other homes or buildings currently under construction in the development. In some cases, the existing size and screw hole pattern of the used protector will match the new threshold. If not, additional holes can be made, and/or the protector can be trimmed to fit a different doorway threshold than the one it was last used on.

The foregoing description details certain embodiments of the invention. It will be appreciated however, that no matter how detailed the foregoing appears, the invention may be embodied in other specific forms without departing from its spirit of essential characteristics. The desired embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A protective device, said device comprising:
a device body comprising a top protective panel configured to overlie a door threshold, wherein at least a portion of the top protective panel is non-opaque;
at least one aperture in the device body; and
at least one fastener extending through said at least one aperture in the device body, wherein said fastener secures the protective device to the door threshold and secures said door threshold in place.

2. The device of claim 1, wherein the at least one aperture is formed after said protective device is placed over the door threshold.

3. The device of claim 1, wherein said device comprises a plastic.

4. The device of claim 3, wherein said device comprises a material selected from: acrylic, polyethelene, or polypropylene, and combinations thereof.

5. The device of claim 3, wherein said device is formed by injection molding.

6. The device of claim 3, wherein said device is formed by extrusion.

7. The device of claim 1, wherein the protective device is configured to permit normal operation of a door after the protective device is placed over the door threshold.

8. The device of claim 1, wherein the upper surface of the protective device has a thickness in the region between the door and the threshold of less than about 30 mil.

9. A protective device, said device comprising:
a top cover portion configured to overlie a door threshold;
at least one side wall;
at least one aperture in the top cover portion of the protective device; and
at least one fastener extending through the at least one aperture, wherein said fastener secures the protective device to the door threshold and secures said door threshold in place.

10. The device of claim 9, wherein the side wall is biased to press against the door threshold.

11. The device of claim 9, wherein the side wall comprises a flange or tab.

12. The device of claim 9, wherein the interior surface of the side wall comprises a surface configured to increase friction between said side wall and the door threshold.

13. The device of claim 9, wherein the interior surface of said side wall comprises an adhesive material.

14. A method of installing a protective device, comprising:
placing the protective device over a door threshold; and
securing both the protective device and the door threshold with the same fastener.

15. The method of claim 14, additionally comprising removing a portion of the protective device prior to placing said protective device over the door threshold.

16. The method of claim 15, wherein removing a portion of a protective device comprises trimming at least one end of the protective device so as to enable the protective device to fit within a door frame.

17. The method of claim 14, additionally comprising forming the at least one aperture in the protective device after placing the protective device over a door threshold.

18. The method of claim 17, wherein forming the at least one aperture comprises forming an aperture overlying a second aperture in the threshold, configured to receive the fastener.

19. The method of claim 14, additionally comprising removing said at least one fastener from a second aperture within the door threshold prior to placing the protective device over said door threshold.

20. A protective device, said device comprising a top protective panel configured to overlie a door threshold, wherein at least a portion of the top protective panel is non-opaque.

21. The device of claim 20, additionally comprising:
at least one aperture in the device body; and
at least one fastener extending through at least one aperture in the device body, wherein said fastener secures the protective device to the door threshold.

22. The device of claim 21, wherein the fastener also secures the threshold in place.

23. The device of claim 20, wherein said device comprises a material selected from: acrylic, polyethelene, or polypropylene, and combinations thereof.

24. A protective device, comprising:
a protective shield;
means for securing the shield to a threshold, wherein said securing means also provide means for securing the threshold in place.
